(19) United States
(12) Patent Application Publication
(10) Pub. No.: US 2025/0288480 A1
(43) Pub. Date: Sep. 18, 2025

(54) KNEE REHABILITATION ACTIVE MOTION MACHINE AND METHOD OF USE

(71) Applicant: D5Wilson Partners LLC, San Antonio, TX (US)

(72) Inventors: Daniel L. Wilson, San Antonio, TX (US); Dustin I. Wilson, Aurora, CO (US); Sarah Anthraper, Dallas, TX (US); Diana Hubbard, Helotes, TX (US); Christian Gabbert, Brownsville, TX (US); Daniel Sauceda, Houston, TX (US); Madeleine Stephens, Dallas, TX (US)

(73) Assignee: D5Wilson Partners LLC, San Antonio, TX (US)

(21) Appl. No.: 19/080,627

(22) Filed: Mar. 14, 2025

Related U.S. Application Data
(60) Provisional application No. 63/566,265, filed on Mar. 16, 2024.

(51) Int. Cl. A61H 1/02

(52) U.S. Cl. CPC A61H 1/0214; A61H 1/024; A61H 2201/5007; A61H 2203/0425; A61H 2230/825

(57) ABSTRACT

A knee rehabilitation active motion machine (KRAM) and method of use. The KRAM provides key benefits for users after undergoing knee replacement or other surgeries. Studies have indicated that pedaling and balance exercises provide better recovery for total knee replacement patients. The adjustable features of a pedaling unit and a moving assembly allow the user to use the KRAM through the entirety of their rehabilitation process. For post-surgery rehabilitation, users will be able to adjust the KRAM parameters to limit their desired flexion and extension due to stiffness or soreness. As rehabilitation progresses, users can electronically increase the flexion and extension angles they can achieve, all the way to a full range of motion of approximately 135 degrees maximum flexion and full extension of approximately 20 to 0 degrees.

### CROSS REFERENCE TO RELATED APPLICATIONS

This patent application is based on and claims priority to U.S. provisional patent application Ser. No. 63/566,265, which is entitled “Knee Rehabilitation Active Motion Machine KRAM, a Medical Stationary Bike,” filed Mar. 16, 2024, the entire disclosure of which is incorporated herein by reference.

### TECHNICAL FIELD OF THE INVENTION

The present invention relates generally to stationary bicycles and, more particularly, but not by way of limitation, to medical rehabilitation stationary bicycles that facilitate recovery after surgery or injury. Methods of using a medical rehabilitation stationary bicycle also are disclosed.

### SUMMARY OF THE INVENTION

The present invention is directed to a stationary bicycle for knee rehabilitation, comprising: a frame; a seat positioned on the frame; a pedaling unit comprising a pedal having a pedal radius formed by the path of the pedal, wherein the pedaling unit is adapted to modify the pedal radius; and a moving assembly for moving the pedaling unit on the frame relative to the seat.

The present invention further is directed to a method of using a knee rehabilitation stationary bicycle, the method comprising the steps of: providing a pedaling unit comprising a pedal having a pedal radius formed by the path of the pedal, wherein the pedaling unit is adapted to modify the pedal radius; and providing a moving assembly for moving the pedaling unit relative to a seat of the bicycle; providing a computer and inputting the data comprising the height of a user and a desired flexion angle; determining the position of the pedaling unit to achieve the desired flexion angle θ based on the data inputted; and automatically moving the pedaling unit to the position on the bicycle to achieve the desired flexion angle.

### BRIEF DESCRIPTION OF THE DRAWINGS

The figures are provided for purposes of illustration only and merely depict typical or illustrative embodiments.

FIG. 1 shows a right perspective view of an illustrative knee rehabilitation active motion machine constructed in accordance with the present invention.

FIG. 2 shows a front view of an illustrative knee rehabilitation active motion machine constructed in accordance with the present invention.

FIG. 3 shows an illustrative pedaling unit of knee rehabilitation active motion machine constructed in accordance with the present invention, wherein the extendible linear actuator rods are retracted, which allows for minimum flexion by decreasing the pedaling diameter.

FIG. 4 shows an illustrative pedaling unit of knee rehabilitation active motion machine constructed in accordance with the present invention, wherein the extendible linear actuator rods are extended which allows for optimum flexion by increasing the pedaling diameter.

FIGS. 5A and 5B show a side-by-side comparison of an illustrative pedaling unit of the knee rehabilitation active motion machine of the present invention wherein the linear actuator rods are retracted in FIG. 5A and wherein the linear actuator rods are extended in FIG. 5B.

FIG. 6 shows an illustrative the linear motion channel assembly of the knee rehabilitation active motion machine of the present invention.

FIG. 7 shows the pedaling unit in cooperative engagement with the linear motion channel assembly.

FIG. 8 shows illustrative standard biometric proportions of the human body, which may be used to relate the height of a user to the partial leg lengths of the user of the knee rehabilitation active motion machine of the present invention.

FIG. 9 shows an illustrative knee flexion triangle, wherein the knee achieves maximum flexion and side C of the triangle represents the distance between the seat and the pedal at the top of the pedaling cycle of the knee rehabilitation active motion machine of the present invention.

FIG. 10 shows an illustration depicting the leg at full extension of a user of the knee rehabilitation active motion machine of the present invention.

FIG. 11 shows both legs of a user during operation of the knee rehabilitation active motion machine of the present invention at the peak of the pedaling cycle, illustrating maximum leg flexion and extension at the same time.

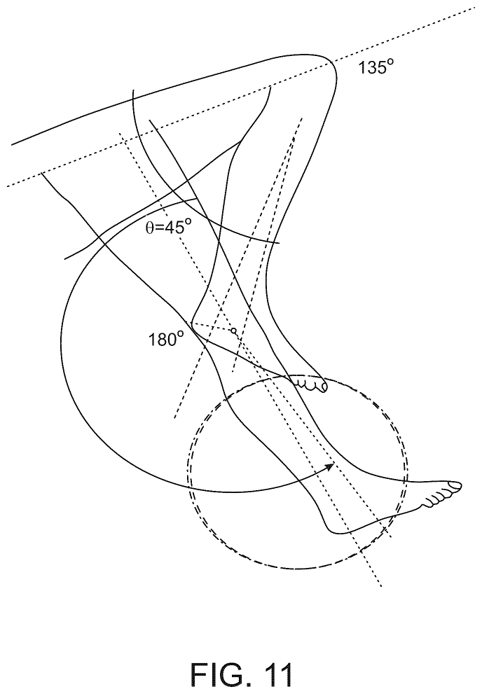

### DETAILED DESCRIPTION OF THE INVENTION

According to the American Academy of Orthpaedic Surgeons, over 700,000 total knee replacements, also known as total knee arthroplasty (“TKA”), are performed in the United States each year. TKA's are expected to continuously increase over the decades, along with the age of the American population. The annual number of TKA's is projected to be over 1.2 million by 2040 and 2.9 million by 2060.

The current standard for post-surgical rehabilitation is for the patient to use a continuous passive motion (“CPM”) machine. A CPM machine gently bends the knee joint back and forth to aid in recovery after a knee injury or knee surgery. The CPM machine performs the work on the joint while the patient remains generally immobile. Although this reduces inflammation, helps with stiffness, improves range of motion, and breaks up scar tissue and adhesions, CPM machines pose many limitations. Primarily, CPM machines do not actively exercise the muscles of the legs, and this lack of motion does not help the patient regain or improve strength. The passive feature of the CPM machine is very controversial and does not seem to benefit the patient's health or improve the recovery time. A better solution would involve active motion and potential cardiovascular benefit, while still achieving the patient's desired flexion and extension angles.

Many studies show that use of a CPM machine, post-surgery, does not provide any benefit to the patient. It has been observed that CPM machines can slow down recovery due to keeping patients in bed, or otherwise immobile, while moving the knee joint. The drawbacks of the CPM machine for knee rehabilitation following surgery requires a new method for post-surgery knee rehabilitation. In addition, standard stationary bikes do not allow the user to have optimum flexion and extension at the same time by changing the height of the seat of the stationary bike.

The knee rehabilitation active motion machine of the present invention provides key benefits for users after experiencing knee replacement or other surgeries. Studies have indicated that pedaling and balance exercises provide better recovery for patients who have undergone a total knee replacement. The adjustable features of the pedals and pedal system allow the user to use the bicycle of the present invention throughout the period of post-surgical recovery during their rehabilitation process. They will be able to adjust the bicycle parameters to limit their desired flexion and extension due to stiffness or soreness. As their rehabilitation progresses, users can increase the flexion and extension angles that the knee can achieve, all the way to a full range of motion of approximately 135 degrees maximum flexion and full extension of approximately 20 to 0 degrees, if desired and able.

Another major benefit of the knee rehabilitation active motion machine of the present invention is that it does not require the user to adjust any features of the bicycle manually. Regular stationary bicycles require that the seat height be adjusted manually by the user to achieve the desired flexion. This results in the user having to mount and dismount the bicycle numerous times to ensure that the seat height is at the correct elevation for the patient to realize the desired flexion during exercise. Frequent mounting and dismounting could further exacerbate injuries and could increase the risk of a possible fall, causing more harm than good.

Lowering the seat on a conventional exercise bike does achieve additional flexion; however, optimal extension is lost as the seat is lowered. For example, an adult riding a small child's bicycle yields maximum flexion, but minimal extension. The knee rehabilitation active motion machine of the present invention allows for optimal extension and flexion by the user.

Studies indicate that pedaling and balancing exercises offer optimistic promise in progressive recovery and rehabilitation following surgery. Stationary exercise bicycles provide cardiovascular benefit because of the active motion required to operate the bicycle. For these reasons, exercise bicycles are a better post-surgical option than CPM machines for patients. The knee rehabilitation active motion machine provides enhancements over a stationary bicycle and allows users to control their recovery while actively engaging muscles in both their surgical and non-surgical legs. Among other advantages, users, through use of a keypad or touchpad and onboard computer, may electronically modify the knee flexion angle without getting off the knee rehabilitation active motion machine. This automatically adjusts the pedal system to allow for the desired flexion and extension as their rehabilitation permits it.

The knee rehabilitation active motion machine of the present invention comprises several elements that aid in rehabilitating the knee after surgery or injury. One component of the active motion machine comprises an electronically adjustable pedal system which eliminates the need for the user to mount and dismount the machine. This is achieved by a linear actuator, which can extend or retract the pedal arm, or linear actuator rod. The foregoing benefits of the knee rehabilitation active motion machine of the present invention also are facilitated by electronically changing the radius of the pedal path or cycle, which achieves maximum flexion and extension in a single pedal cycle. These adjustable features allow the user to optimize the entirety of their rehabilitation process.

The knee rehabilitation active motion machine of the present invention provides software that offers the user control over movement of the pedaling unit and the pedals to the correct position to enable the user to obtain the desired extension and flexion during the rehabilitation exercise. The software is written into a touchpad interface and onboard computer that receives user input of anthropometric data. The software calculates the position where the pedaling unit and pedals need to move automatically in order to achieve the desired extension and flexion angles during the rehabilitation workout. This allows the pedal unit to be electronically raised closer to, or lowered away from, the user, thus eliminating the need for manual action in adjusting the seat height as in a conventional stationary exercise bicycle. The present invention, therefore, eliminates the need for a user to repeatedly mount and dismount the bike to modify the seat height to achieve optimal flexion and extension at all times while exercising.

The terminology used herein is for the purpose of describing the invention and is not intended to be limiting of the invention. Unless otherwise defined, all terms in this document should be understood as having a meaning that is consistent with their meaning in the context of the invention as described herein. As used herein “approximately” and “generally” refer to manufacturing tolerances of permissible variations in physical properties of the embodiments disclosed herein. Dimensions, orientations, and/or configurations disclosed herein may have some acceptable variation within manufacturing tolerances without significantly affecting functioning of the disclosed embodiments. For example, while parallel and perpendicular relative arrangements and directions may be ideal, such configurations may not be perfectly achievable. Thus, substantially or approximately perpendicular and the like refers to a relative orientation or configuration within manufacturing tolerances. Similarly, generally or substantially linear and the like refers to a configuration within manufacturing tolerances.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known”. The presence of broadening words and phrases such as “one or more,” “at least,” “but not limited to” or other like phrases in some instances shall not be read to mean that the narrower case is intended or required in instances where such broadening phrases may be absent. The use of the term “component” or “assembly” or “unit” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple location.

Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, “flexion” of the leg means the movement of the lower leg, i.e., from the knee to the foot, posteriorly relative to the thigh, thus, bending the leg at the knee, and “extension” means the movement of the lower leg anteriorly relative to the thigh, thus, straightening the leg at the knee.

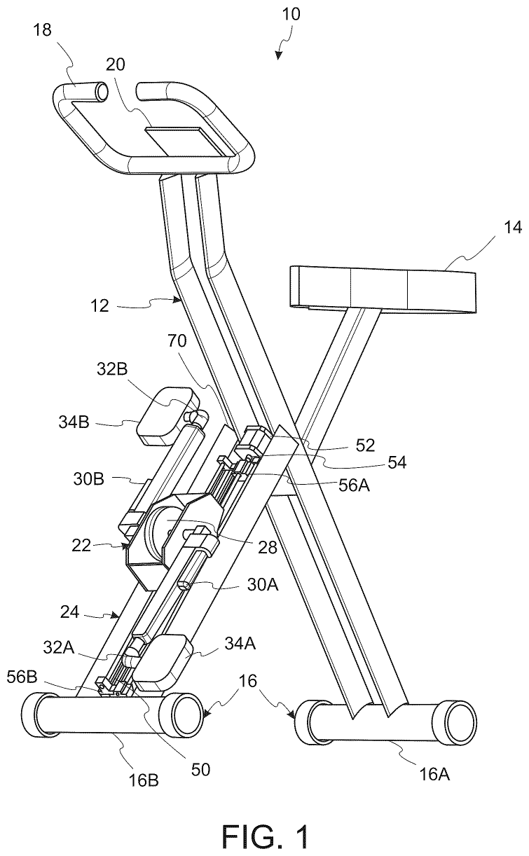

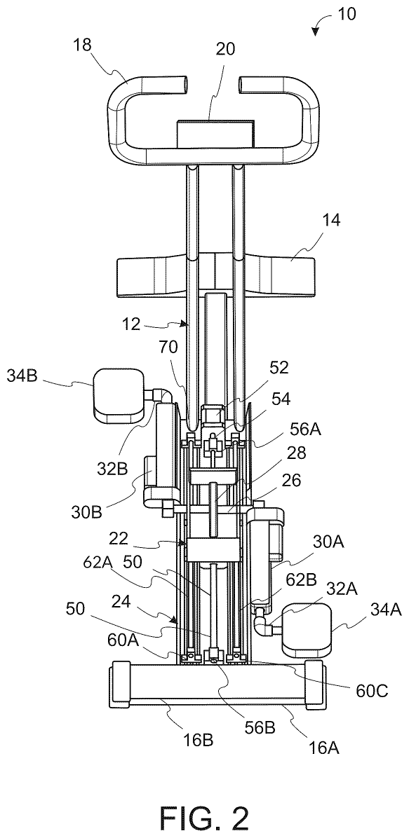

Turning now to the drawings in general, and to FIGS. 1 and 2, in particular, there is shown therein an illustrative knee rehabilitation active motion machine 10 of the present invention. The knee rehabilitation active motion machine 10 of the present invention also may be referred to herein as the KRAM or the machine. The KRAM 10 comprises a frame 12, which may be generally upright in orientation. It will be appreciated that the frame 12 of the KRAM 10 alternatively may orient the user of the machine 10 in a recumbent position or at some orientation in between vertical and horizontal, inclusive.

The frame 12 of the KRAM 10 is provided with a seat 14 to support a user during operation of the machine 10. The frame 12 comprises a base 16 for supporting the KRAM 10 on a substrate. The base 16 stabilizes the frame 12 in the desired orientation during exercise. In one embodiment of the invention, the base 16 comprises a plurality of generally parallel stabilizer bars 16A and 16B. However, it will be appreciated that the base 16 may comprise any stabilization means, including, but without limitation, one or more plates, an elevated platform, or a training stand.

The KRAM 10 further comprises handlebars 18 which are located on the anterior of the machine 10, in front of the seat 14. The handlebars 18 are designed to be held or gripped by the user to maintain balance while operating the machine 10. The handlebars 18 may be adjusted up or down to suit the body type and comfort level of the user of the KRAM 10. The handlebars 18 may be any type of handlebar, including risers, drop handlebars, flat bars, bullhorn bars, Van rysel handlebars, mustache bars, aerobars, cruiser bars, butterfly bars, ape hangers or cruiser handlebars.

The KRAM 10 further comprises a pedaling unit 22 and a moving assembly 24. In a manner yet to be described, the moving assembly 24 moves or guides the pedaling unit 22 longitudinally, horizontally and/or transversely on the frame 12 of the KRAM, while the pedaling unit 22 extends and retracts according to the user's desired angle of flexion, in a manner yet to be described. An onboard computer with a display element 20, such as a touchpad or trackpad, allows the user to input the desired height and the desired flexion angle, which can be adjusted automatically without the user mounting and dismounting the KRAM 10 to manually adjust the height of the seat 14. The pedaling unit 22 and the moving assembly 24 enable a user to operate the KRAM 10 at any desired flexion and extension angles, which are established automatically with input of user anthropometric data into the onboard computer through the display element 20. This is a much safer way to exercise, using various desired flexion angles during a workout.

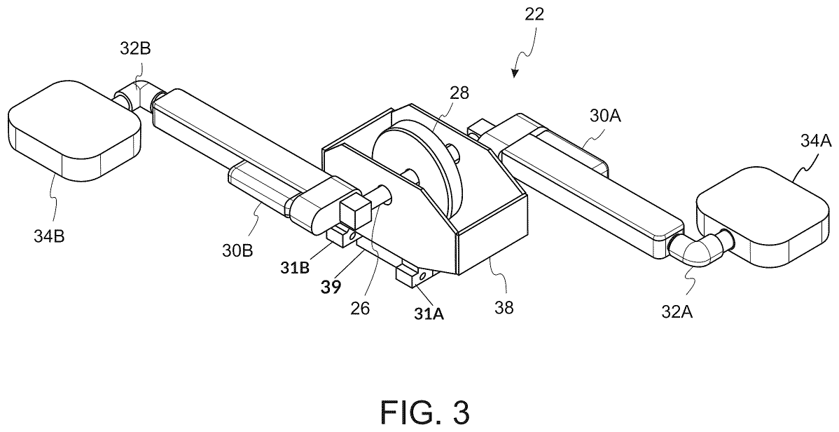

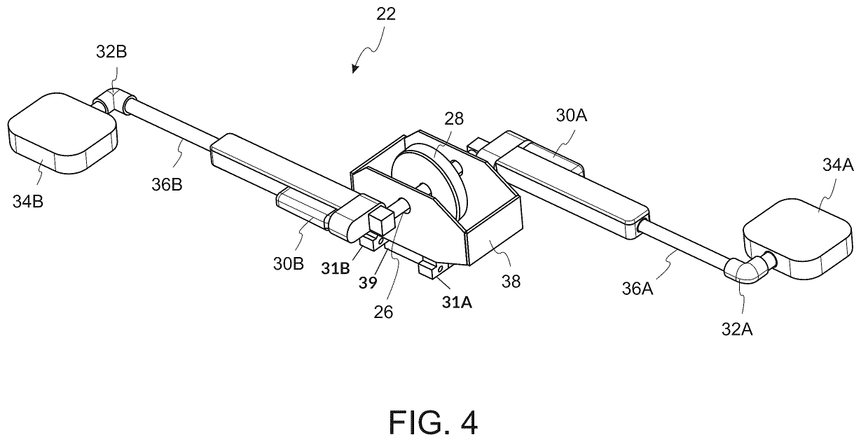

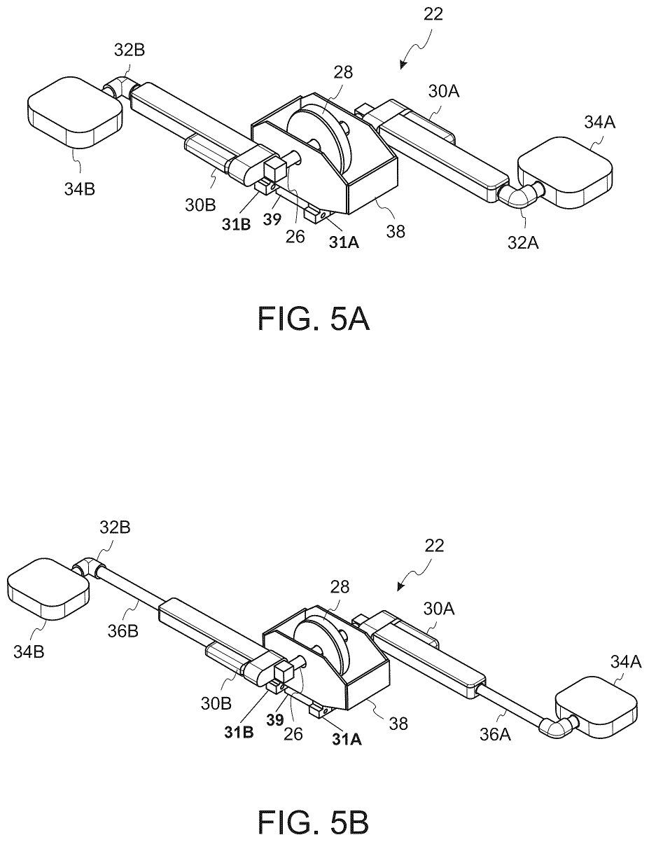

Turning now to FIGS. 3, 4, 5A and 5B, but with continuing reference to FIGS. 1 and 2, the pedaling unit 22 comprises a mechanism that extends electronically, in a manner yet to be described, to the desired position according to the user's height and desired flexion angle. The pedaling unit 22 comprises an axle 26 which may extend through a flywheel 28, connecting two linear actuators 30A and 30B. Two pedal-to-actuator adapters 32A and 32B permit attachment and cooperative engagement of pedals 34A and 34B to extendable linear actuator rods 36A and 36B, respectively, as shown in FIGS. 4 and 5B. The extendible linear actuator rods 36A and 36B are actuated by means of the onboard computer 20 and are activated with a voltage signal sufficient to extend or retract the linear actuator rods 36A and 36B to achieve the desired flexion angle. The required length of extension of the actuator rods 36A and 36B is calculated automatically by the onboard computer 20 based upon input of the user's height and desired flexion angle. The pedal-to-actuator adaptors 32A and 32B attach the pedals 34A and 34B to the linear actuators 30A and 30B, respectively. The linear actuators 30A and 30B are powered by the onboard computer 20 and extend according to the instruction provided by the computer after calculating the correct distance pedaling radius. The extendable linear actuator rods 36A and 36B may be an included component of the linear actuators 30A and 30B and need no further intervention for activation/extension beyond the electronic signal provided to the linear actuators 30A and 30B.

The extendible linear actuator rods 36A and 36B may extend telescopically from the linear actuators 30A and 30B. When activated, the two linear actuators 30A and 30B set the length of linear actuator rods 36A and 36B, meaning the distance at which the linear actuator rods 36A and 36B will extend from the linear actuators 30A and 30B, respectively, according to the user's height and desired flexion angle. In one embodiment of the invention, the length of each of the extendible linear actuator rods 36A and 36B ranges from about six (6) inches (15.24 cm) to about twelve (12) inches (30.48 cm), while the total length of each of the linear actuators 30A and 30B plus the length of the corresponding extendible linear actuator rod 36A or 36B may range from about six (6) inches (15.24 cm), when the linear actuator rod is fully retracted, to eighteen (18) inches (45.72 cm) when the linear actuator rod is fully extended. In one embodiment of the invention, the linear actuators 30A and 30B have a length of 6.6 inches (16.764 cm) and the extendible linear actuator rods 36A and 36B have a length of 6 inches (15.24 cm), meaning that the final full extension of each linear actuator 30A and 30B plus its corresponding linear actuator rod 36A and 36B, when fully extended, will be 12.6 inches (32.004 cm).

With continuing reference to FIGS. 3, 4, 5A and 5B, the pedaling unit 22 may comprise a bracket 38 that houses the axle 26 and the flywheel 28. The bracket 38 may be supported in cooperative engagement with the linear actuator 30A via linear motion support bearings 31A and 31B, which are connected via a mechanism, such as a ball screw nut and housing 39, which enable the pedaling unit 22 to move along or in cooperation with the moving assembly 24 in a manner yet to be described. It will be appreciated that the bracket 38 also may be supported in cooperative engagement with linear actuator 30B via linear motion support bearings and a ball screw nut, which are not shown in FIGS. 3, 4, 5A and 5B but which correspond to linear motion support bearings 31A and 31B. The linear motion support bearings 31A and 31B and the two other linear support bearings which are not shown, facilitate movement of the pedaling unit 22 in engagement with the moving assembly 24 in a manner yet to be described.

A side-by-side comparison of the pedaling unit 22 in a fully retracted state and a fully extended state is shown in FIGS. 5A and 5B. FIG. 5A depicts the pedaling unit 22 with linear actuator rods 36A and 36B retracted, while FIG. 5B depicts the pedaling unit 22 with the linear actuator rods 36A and 36B extended. Retraction of the linear actuator rods 36A and 36B creates a smaller pedaling diameter, allowing for a smaller knee flexion angle, while extension of the linear actuator rods 36A and 36B creates a larger pedaling diameter, allowing for a greater knee flexion angle, in a manner yet to be described. This configuration allows for optimum flexion by automatically increasing the pedaling diameter.

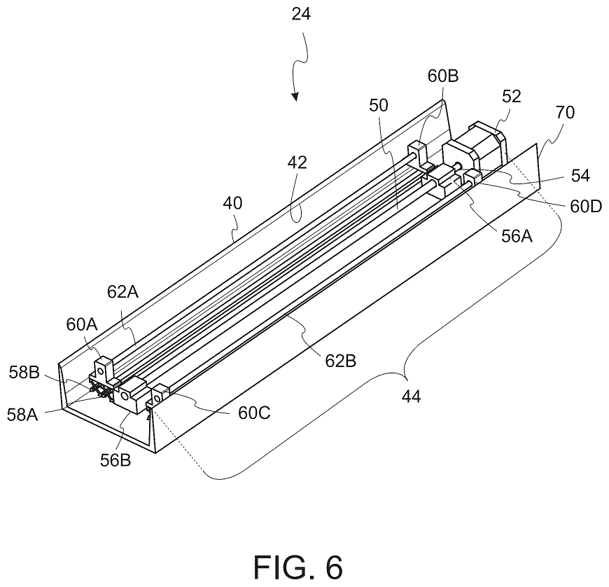

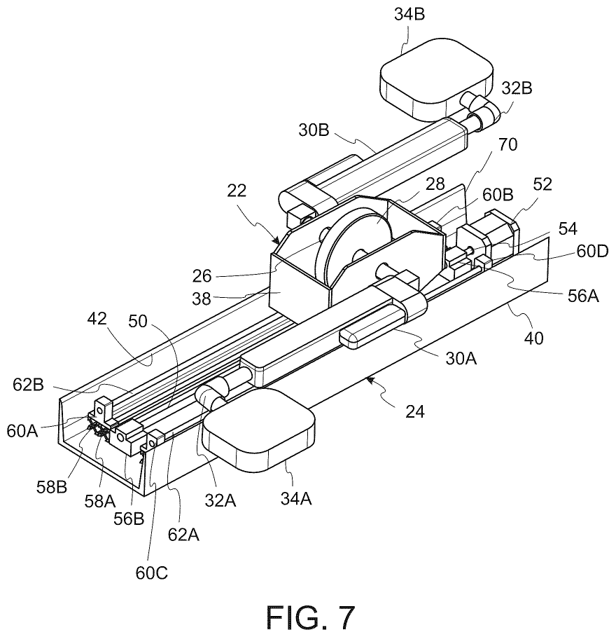

Turning now to FIGS. 6 and 7, the moving assembly 24 moves the pedaling unit 22 longitudinally, horizontally or transversely, or some combination thereof, on the frame 12 of the KRAM 10 to accommodate differences in height and various desired knee flexion angles. The moving assembly 24 comprises a housing 40 and a linear motion guide system 44 comprising a stationary rail and a moveable carriage. The housing 40 forms a channel 42 to accommodate the linear motion guide system 44. In one embodiment of the invention, the linear motion guide system 44 comprises a ball screw lead 50 which is rotated by a motor 52, such as, for example, a Z-lead stepper motor. A shaft coupling 54 connects the motor 52 to a support bearing 56A, which holds the ball screw lead 50 in place along with support bearing 56B. On one side of the ball screw lead 50 are two components 58A and 58B which support shaft supports 60A and 60B. In one embodiment of the invention, components 58A and 58B comprise T-slot extrusions. Likewise, on the other side of the ball screw lead 50 are two components, such as T-slot extrusions, which are not visible in FIG. 6, but which support shaft supports 60C and 60D. Two linear motion shaft rods 62A and 62B extend between the two shaft supports 60A, 60B and between shaft supports 60C and 60D, respectively. Shaft supports 60A and 60B are adapted to support linear motion shaft rod 62A, while shaft supports 60C and 60D are adapted to support linear motion shaft rod 62B. In one embodiment of the invention, the shaft supports 60A, 60B, 60C and 60D may be SK8 linear bearing rail supports.

The adaptable pedaling unit 22 and moving assembly 24 work in cooperative engagement to permit patients, as their rehabilitation progresses, to increase the achievable flexion and extension, all the way to a full range of motion of approximately 135 degrees maximum flexion and full extension of approximately 20 to 0 degrees, if desired. The mechanism by which the pedaling unit 22 moves relative to the frame 12 and/or seat 14 of the KRAM 10 will now be explained. As shown in FIG. 7, the bracket 38 of the pedaling unit 22 is positioned atop of linear motion shaft rods 62A and 62B, via the four linear motion support bearings, two of which are shown in FIGS. 3, 4, 5A, and 5B as elements 31A and 31B, under the bracket 38. The ball screw nut and ball screw nut housing 39 shown in FIGS. 3, 4, 5A and 5B connect the bracket 38 to the ball screw lead 50 of the linear motion guide system 44 of the moving assembly 24. The four linear motion support bearings, including linear motion support bearings 31A and 31B, glide parallel to the ball nut and ball nut housing 39 to guide the entire pedaling unit 22 longitudinally, horizontally and/or transversely over the moving assembly 24. When the motor 52 is activated, the ball screw lead 50 turns, subsequently raising or lowering the ball screw nut 39 and carrying bracket 38 over the housing 40 of the pedaling unit 22. The linear motion support bearings 31A and 31B and their counterparts on the opposite side of the bracket 38, prevent the bracket from rocking side to side and support the peripheral weight of the pedaling unit 22.

It now will be appreciated that the four linear motion support bearings, including 31A and 31B, are positioned at each corner below the bracket 38 and contain holes to link to the linear motion shaft rods 62A and 62B and one threaded ball screw nut in the ball screw nut housing 39 below the bracket 38 that attaches to the ball screw lead 50. Linear motion support bearings 31A and 31B, along with the ball screw nut and its ball screw nut housing 39 are attached to the bracket 38 and prevent the bracket 38 from rocking side to side and also support the peripheral weight of the bracket assembly. The pedaling unit sits atop the ball nut housing 39, allowing for an adjustable position according to the entered or inputted height of the user and the desired flexion angle. The two linear motion shaft rods 62A and 62B are located on either side of the ball screw lead 50 to support the pedaling unit 22 via the four linear motion support bearings, including 31A and 31B and the other two linear motion support bearings under the bracket 38 on the opposite side which are not shown, as the peddling unit 22 travels along the ball screw lead 50.

The user exercises on the KRAM 10 at any desired flexion and extension angles, which are established automatically with input of user anthropometric data into the onboard computer and touchpad, keypad or keyboard 20. Software installed on the onboard computer 20 on the KRAM 10 allows for the desired knee flexion by calculating the proper distance that the pedals 34A and 34B should be from the seat 14 and the length of the linear actuator rods 36A and 36B to enable a user of any height to achieve a desired flexion angle. Once the user's height is input, the user inputs a target flexion angle, which at any point during the exercise routine can be changed without requiring the user to dismount the KRAM 10 and manually change the positioning of the machine's 10 components, including the height of the seat 14, to obtain the desired flexion angle. If the initial settings cause discomfort to the user due to excess flexion, an adjustment can quickly and automatically be made on the touchpad 20 to adjust the length of the linear actuator rods 36A and 36B and correct the position of the pedals 34A and 34B and the flexion angle. As such, the KRAM 10 can accommodate users of all heights as they increase knee flexion during rehabilitation and workout sessions. This configuration allows for optimum flexion by automatically increasing the pedaling diameter.

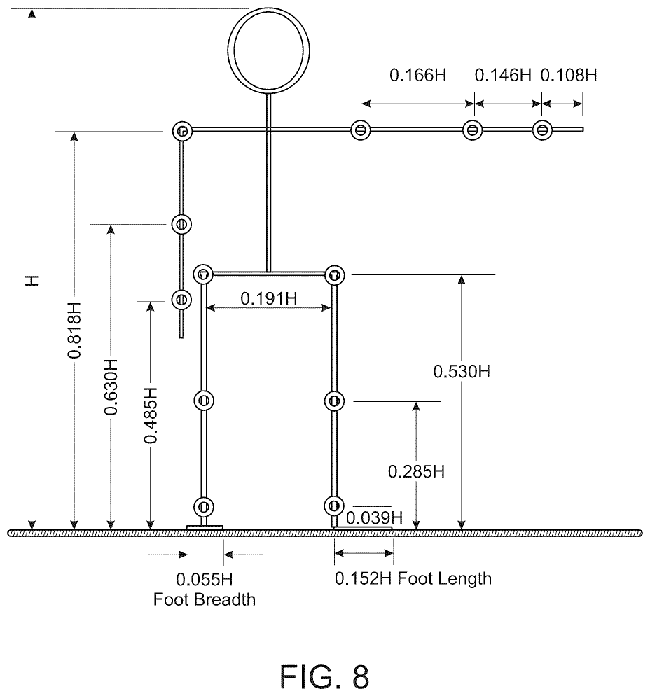

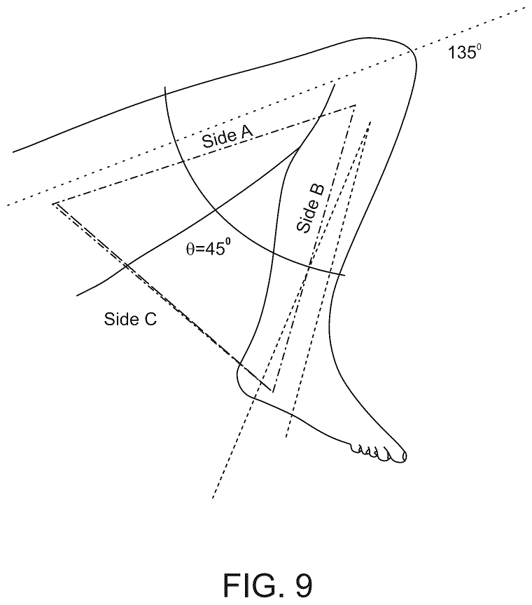

A discussion of the software of the KRAM 10 will now be provided. Studies have shown that there are statistically significant correlations between hand and foot indices, and ratios of leg lengths, for example, the length of the femur to height of the body. Likewise, the standard human body proportion suggests that an individual's arm span, measured from fingertip to fingertip with arms outstretched, is approximately equal to their height. FIG. 8 illustrates some biometric proportions of the human body, and biometric modeling of the human body mathematically can be used to relate the user's height to partial leg lengths. The KRAM 10 software allows for the calculation and automation of the KRAM 10 positioning by analyzing the knee flexion triangle, seen in FIG. 9. The knee flexion triangle is the relationship of the knee's bending (i.e. flexion angle) between the thigh and lower leg of the user and side C, shown in FIG. 9. The software utilizes the user's height and anthropometric data for average height-to-leg proportions. These proportions, in conjunction with the selected flexion angle, are used by the KRAM 10 software to solve the knee flexion angle, including the distance of the pedals to the bike seat, and the length of the linear actuator rods 36A and 36B needed to achieve the selected flexion angle. The calculation returns the length of the side of the triangle that is opposite the bend of the knee, shown as side C in FIG. 9.

The KRAM 10 software uses relationships based on anthropometric data, such as that shown in FIG. 8, to approximate user leg segment lengths, for the upper leg, or thigh, and the lower leg, from the knee to the bottom of the foot, and performs the calculations necessary to automatically move the pedaling unit 22 and the two linear actuators 30A and 30B to set the length of linear actuator rods 36A and 36B into an appropriate position for the user's rehabilitation workout session. Leg segment lengths are proportional to user height, and, therefore, the lengths of the thigh and the lower leg can be derived from the inputted height. FIG. 8 illustrates various body segments as factors of the person's height. In the operation of the software, the user's height is multiplied by a factor of 0.245 to approximate the length of the thigh, illustrated as side A in FIG. 9. The user's height is multiplied by a factor of 0.285 to approximate the length of the leg from the knee to the foot, illustrated as side B in FIG. 9. These two lengths are the two sides of the knee flexion triangle, shown in FIG. 9, from which the knee flexion angle can be calculated.

Knee flexion is calculated by measuring clockwise from the knee, the inner angle θ formed by the thigh and the lower leg, when bending, and is equal to 180 degrees minus the measured angle. By way of example, as demonstrated in FIG. 9, a flexion of 135 degrees is calculated from a measured inner angle θ of 45 degrees (180°-45°) . Given the two leg segment lengths and the desired flexion angle, the length of side C can be solved by the KRAM software using the equation shown in EQ 1:

$$C = \sqrt[2]{{A}^{2} + {B}^{2} - 2 AB cos ( θ )} \qquad EQ 1$$

Where: A=the length of the thigh (side A in FIG. 9)
   B=the length from the knee to the foot (side B in FIG. 9)
   C=the length side C opposite side A and side B
   θ=the inner angle formed by side A and side B.

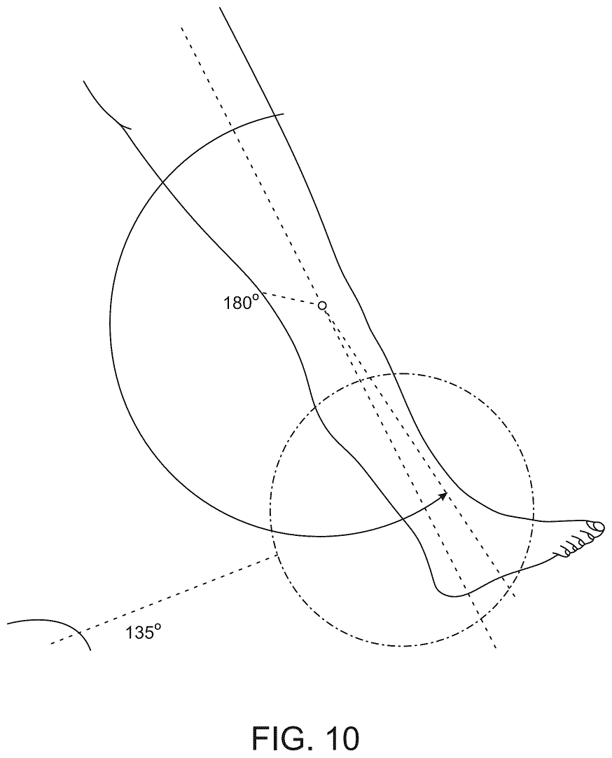

Turning now to FIGS. 9 and 10, the software calculates the radius of the pedal path or cycle R_{P} such that, at the top of the circular pedal path, the user achieves the desired flexion and achieves full extension at the bottom of the pedaling cycle. The radius of this pedal path R_{P} is found by subtracting the full leg length L_{F}, which is the height of the user multiplied by 0.53, and side C and dividing by two, using the equation shown in EQ 2:

$${R}_{P} = ( {L}_{F} - C ) / 2 \qquad EQ 2$$

Where: R_{P}=the radius of the pedal path
   L_{F}=the full length of the leg from the knee to the bottom of the foot
   C=the length of side C opposite side A and side B
      This equation yields the radius of the pedal path R_{P}, which is shown in EQ 3:

$${R}_{P} = {L}_{L C} + {L}_{ELAR} \qquad EQ 3$$

Where: R_{P}=the radius of the pedal path
   L_{LC}=the length of the linear actuator 30A or 30B
   L_{ELAR}=the length of the extended linear actuator rod 36A or 36B
   C=the length of side C opposite side A and side B
      The distance between the pedals 34A and 34B and the seat 14 D_{PC} is the sum of the length of side C and the radius of the pedal path R_{P}, shown in EQ 4:

$${D}_{P S} = C + {R}_{P} \qquad EQ 4$$

Where: R_{P}=the radius of the pedal path
   L_{F}=the full length of the leg from the knee to the bottom of the foot
   C=the length of side C opposite side A and side B
      Depending upon the dimensions of the KRAM 10, an offset O is subtracted from the distance D_{PS} to account for the distance between the seat 14 and a top side 70 of the moving assembly 24 to determine the position of the pedaling unit 22 on the moving assembly 24 P_{PU-MA}, shown in EQ5:

$${P}_{PU - MA} = {D}_{P S} - O \qquad EQ 5$$

$$Where : {P}_{PU - MA} = {D}_{P S} - O$$

D_{PS}=the position of the pedaling unit 22 on the moving assembly 24
O=the offset measured by the distance between the seat 14 and a top side 70 of the moving assembly 24

In one embodiment of the invention, the offset is twenty-seven (27) inches. After entering the desired data via the keypad 20, the software determines the P_{PU-MA} and sends one or more signals to power the motor 52 and the linear actuators 30A and 30B to position the pedals 34A and 34B into the correct configuration, by extending the linear actuator rods 36A and 36B according to the user's height and desired flexion angle. The linear actuators 30A and 30B are powered by the onboard computer 20 and extend according to the instruction provided by the computer after calculating the correct distance P_{PU-MA} and the pedaling radius R_{P}.

The method and operation of the invention will now be explained. The foregoing description of the invention is incorporated herein. A method of using a knee rehabilitation active motion machine is provided. A pedaling unit 22 is provided which electronically adjusts the pedals 34A and 34B and which eliminates the need for the user to mount and dismount the machine 10. This also changes the radius R_{P} of the pedal path or cycle, which achieves a desired flexion and maximum extension in a single pedal cycle. A moving assembly 24 is provided to move the pedaling unit over the frame 12 of the KRAM 10. The motion and location of pedaling unit 22 and of the extension of the linear actuator rods 36A and 36B is determined and/or facilitated by software that offers the user control over movement of the pedaling unit 22 and the pedals 34A and 34B to the correct position to enable the user to obtain the desired extension and flexion during the rehabilitation exercise. The software calculates the position where the pedaling unit and pedals need to move automatically in order to achieve the desired extension and flexion angles during the rehabilitation workout. This allows the pedal unit to be electronically raised closer to, or lowered away from, the user, thus eliminating the need for manual action in adjusting the seat height as in a conventional stationary exercise bicycle. The method of the invention allows for the desired knee flexion of a user by calculating the proper distance that the pedals 34A and 34B should be from the seat 14 and the length of the linear actuator rods 36A and 36B in order for a user of any height to achieve a desired flexion angle. Once the user's height is input, the user inputs a target flexion angle, which, at any point during the exercise routine, can be changed without requiring the user to dismount the KRAM 10 and manually change the positioning of the its components, namely the seat, to obtain the desired flexion angle. If the initial settings cause discomfort to the user due to excess flexion, an adjustment can quickly, and automatically, be made on the touchpad to correct the position of the pedals 34A and 34B and the flexion angle. In so doing, the KRAM 10 accommodates users of all heights and recovery stages as users improve and increase knee flexion during a workout session and during the recovery process.

The invention has been described above both generically and with regard to specific embodiments. Although the invention has been set forth in what has been believed to be preferred embodiments, a wide variety of alternatives known to those of skill in the art can be selected with a generic disclosure. Changes may be made in the combination and arrangement of the various parts, elements, steps and procedures described herein without departing from the spirit and scope of the invention as defined in the following claims.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

We claim:

1. A stationary bicycle for knee rehabilitation, comprising:
a frame;
a seat positioned on the frame;
a pedaling unit comprising a pedal having a pedal radius formed by the path of the pedal, wherein the pedaling unit is adapted to modify the pedal radius; and
a moving assembly for moving the pedaling unit on the frame relative to the seat.

2. The stationary bicycle for knee rehabilitation of claim 1, wherein the pedaling unit and the moving assembly are adapted to enable a user to operate the bicycle at a selected flexion angle and a selected extension angle of the leg of the user.

3. The stationary bicycle for knee rehabilitation of claim 2, wherein the pedaling unit further comprises an extendable linear actuator rods in cooperative engagement with the pedal and wherein maximum flexion and extension of the leg of the user are achieved in a single pedal cycle by electronically changing the pedal radius.

4. The stationary bicycle for knee rehabilitation of claim 2 wherein the pedaling unit further comprises:
a flywheel;
an axle positioned through the flywheel;
a linear actuator in cooperative engagement with the axle, the linear actuator having a length;
a pedal-to-actuator adapter in cooperative engagement with the pedal and the linear actuator;
an extendible linear actuator rod in cooperative engagement with the linear actuator and the pedal-to-actuator adaptor, the linear actuator rod having a length;
wherein the linear actuator sets the length of the linear actuator rod according to a height of the user and a desired flexion angle of the leg of the user.

5. The stationary bicycle for knee rehabilitation of claim 4 wherein the length of the linear actuator rod plus the length of the extendible linear actuator rod at full extension ranges from about 6 inches to about 18.

6. The stationary bicycle for knee rehabilitation of claim 2 wherein the moving assembly moves the pedaling unit longitudinally, horizontally or transversely on the frame of the bicycle to accommodate differences in the height of the user and in flexion and extension angles of the leg of the user.

7. The stationary bicycle for knee rehabilitation of claim 6, wherein the moving assembly comprises a housing and a linear motion guide system comprising a stationary rail and a moveable carriage.

8. The stationary bicycle for knee rehabilitation of claim 6, wherein the moving assembly comprises:
housing forming a channel;
a linear motion guide system positioned within the housing, the linear motion guide system comprising:
a ball screw lead;
a motor for rotating the ball screw lead;
a shaft coupling connecting the motor to a support bearing which holds the ball screw lead in place; and
two linear motion shaft rod positioned on either side of the ball screw lead.

9. The stationary bicycle for knee rehabilitation of claim 7, wherein the pedaling unit is positioned over the moving assembly and wherein the linear motion shaft supports guide the pedaling unit over the frame.

10. The stationary bicycle for knee rehabilitation of claim 9, further comprising software for calculating the distance that the pedal should be from the seat and the length of the linear actuator rod to achieve the desired flexion angle and extension angle of the user.

11. The stationary bicycle for knee rehabilitation of claim 10, wherein the pedal radius R_{P} is equal to the length of the linear actuator plus the length of extended linear actuator rod.

12. The stationary bicycle for knee rehabilitation of claim 11, wherein the software calculates a distance between the pedal and the seat and calculates a side C of a flexion triangle defined by the flexion angle theta between the thigh and lower leg of the user and a side C opposite the flexion angle, and wherein the distance between the pedal and the seat is the sum of the length of side C and the radius of the pedal path R_{P}.

13. The stationary bicycle for knee rehabilitation of claim 12, wherein the position of the pedaling unit on the frame is determined by sum of the length of side C and the radius of the pedal path R_{P} less an offset measured by the distance between the seat and a top side of the moving assembly.

14. A method of using a knee rehabilitation stationary bicycle, the method comprising the steps of:
providing a pedaling unit comprising a pedal having a pedal radius formed by the path of the pedal, wherein the pedaling unit is adapted to modify the pedal radius; and
providing a moving assembly for moving the pedaling unit relative to a seat of the bicycle;
providing a computer and inputting data comprising the height of a user and a desired flexion angle θ;
determining the position of the pedaling unit to achieve the desired flexion angle θbased on the data inputted; and
automatically moving the pedaling unit to the position on the bicycle to achieve the desired flexion angle θ.

15. The method of claim 14 further comprising the step of providing an extendible and retractable linear actuator rod in cooperative engagement with the pedal, the linear actuator rod having a length.

16. The method of claim 15 further comprising the steps of providing a linear actuator having a length to house the linear actuator rod and calculating a pedal radius that is equal to the sum of the length of the linear actuator rod and the length of the linear actuator.

17. The method of claim 16 further comprising the step of calculating a flexion triangle defined by the flexion angle θ between the thigh and lower leg of the user and a side C opposite the flexion angle θ.

18. The method of claim 17 further comprising the step of calculating the distance D_{PS} between the pedal and the seat and wherein the distance D_{PS} between the pedal and the seat is the sum of the length of side C and the radius of the pedal path R_{P}.

19. The method of claim 18 further comprising the step of determining the position of the pedaling unit on the moving assembly P_{PU-MA}, by subtracting an offset from the distance between the pedal and the seat D_{PS}, wherein the offset is determined by the distance between the seat and a top side of the moving assembly.

20. The method of claim 19 wherein the step of automatically moving the pedaling unit to the position on the bicycle to achieve the desired flexion angle comprises the step of automatically moving the pedaling to the position P_{PU-MA}.
